(19) United States
(12) Patent Application Publication
(10) Pub. No.: US 2006/0248764 A1
(43) Pub. Date: Nov. 9, 2006

(54) Craft kit

(76) Inventor: Joseph Spiegelberg, Anaheim, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/348,936

(22) Filed: Feb. 6, 2006

Related U.S. Application Data
(60) Provisional application No. 60/650,260, filed on Feb. 4, 2005.

(51) Int. Cl. G09F 7/12

(52) U.S. Cl. 40/594

(57) ABSTRACT

According to one aspect of the present invention, a kit and a method for the modification, customization and/or personalization of scrapbooks, picture frames, boxes and the like is provided. The kit may comprise instructions, at least one cutting pattern, a main article comprising an adhesive on at least a portion of its surface with a removable protective layer covering the adhesive, and at least one covering portion having an adhesive on at least a portion of its surface with a removable protective layer covering the adhesive. The kit permits a user to make use of old materials to customize items, such as scrapbooks and picture frames. The kit also allows a user to better personalize items that may be kept or that may be provided to others as gifts.

### CROSS-REFERENCE TO RELATED APPLICATIONS

This application claims the benefit of U.S. Provisional Application No. 60/650,260, filed Feb. 4, 2005 which is herein incorporated by reference in its entirety.

### BACKGROUND OF THE INVENTION

1. Field of the Invention

The present inventions relate generally to kits, and methods of assembling such kits, for the modification, customization, and/or personalization of scrapbooks, picture frames, boxes, and the like.

2. Description of the Related Art

Many types of scrapbooks, picture frames, and the like are sold pre-assembled and pre-decorated. These products provide many design options, but there is no easy way of personalizing them. Rather, one interested in personalizing the items must purchase a number of separate items, making customization a difficult task.

### SUMMARY OF THE INVENTION

A need exists for a kit that allows a user to easily create personalized items such as a scrapbook or the like. Aspects or embodiments of the present disclosure include kits and methods of using them. Embodiments of such kits may include the object to be personalized, as well as the tools necessary to complete the personalization in a self-contained package. Advantages of the present invention include enabling users to incorporate materials that have sentimental value and may already be in their possession into customized scrapbooks, picture frames and the like. For example, a user could use embodiments of the invention to customize a scrapbook with fabric from an old dress, quilt, or the like. In addition, the ability to customize scrapbooks and the like is particularly well-suited for allowing a user to assemble and provide a personalized and meaningful gift to a friend or a loved one or to keep for the user's own enjoyment.

A kit for use in modifying the outward appearance of an article is disclosed. The kits comprise at least one cutting pattern, a main article comprising an adhesive on at least a portion of its surface and at least one covering portion comprising an adhesive on at least a portion of its surface. In some embodiments, the kit further comprises a covering material for use with the main article. In some embodiments, the main article is a book.

In some embodiments of the invention, a kit for use in modifying the outward appearance of an article is disclosed. The kit comprises instructions, at least one cutting pattern, a main article comprising an adhesive on at least a portion of its surface with a removable protective layer covering the adhesive and at least one covering portion having an adhesive on at least a portion of its surface with a removable protective layer covering the adhesive.

In some embodiments, the kit further comprises a covering material for use with the main article. In some embodiments, the covering material is a fabric. In some embodiments, the main article is a book. In some embodiments, the book is a scrapbook. In some embodiments, the covering portions are cover boards configured for use with a book. In yet other embodiments, the main article is a picture frame.

A method for modifying the outward appearance of an article is disclosed. The method comprises supplying at least one cutting pattern, supplying a main article comprising an adhesive on at least a portion of its surface with a removable protective layer covering the adhesive, supplying at least one covering portion comprising an adhesive on at least a portion of its surface with a removable protective layer covering the adhesive and supplying instructions for assembling the main article and the at least one covering portion. In some embodiments of the method, the main article is book. In other embodiments of the method, the main article is a picture frame.

### BRIEF DESCRIPTION OF THE DRAWINGS

A general description of a kit and method of using the same that implements the various features of the invention will now be described with reference to the drawings. The drawings and the associated descriptions are provided to illustrate embodiments of the invention and not to limit the scope of the invention.

FIG. 1 is a schematic of an exemplary kit for use according to an embodiment of the invention.

FIG. 2a is a schematic of a first side of an exemplary cover board for use according to an embodiment of the invention.

FIG. 2b illustrates a schematic of a second side of an exemplary cover board for use according to an embodiment of the invention.

FIG. 3 is a schematic of one embodiment of an assembled interior of a scrapbook.

FIG. 4 is a schematic illustrating one embodiment of the relationship between a cover board and an assembled interior.

FIG. 5 is a schematic of one embodiment of a cutting pattern.

FIG. 6 is a schematic of a cutting pattern as used with a covering material according to one embodiment.

FIG. 7 is another schematic of a cutting pattern and a covering material according to one embodiment.

FIG. 8 is a schematic of one embodiment of a cover board with a protective layer partially removed to expose an adhesive surface.

FIG. 9 is another schematic of one embodiment of a cover board with more of a protective layer removed to expose an adhesive surface.

FIG. 10 is a schematic of one embodiment of a cover board being centered over a covering material.

FIG. 11 is a schematic of a cover board being applied to a covering material according to one embodiment.

FIG. 12 is a schematic of a further step of applying a cover board to a covering material according to one embodiment.

FIG. 13 is a schematic of a further step of applying a cover board to a covering material according to one embodiment.

FIG. 14 illustrates removing a protecting layer from an adhesive surface of a scrapbook's assembled interior according to one embodiment.

FIG. 15 is a schematic of one embodiment of a cover board being applied to an assembled interior of a scrapbook.

FIG. 16 is a schematic of one embodiment of an assembled scrapbook.

FIG. 17 is a schematic of one embodiment of an assembled scrapbook.

FIG. 18 illustrates parts for a kit according to one embodiment of the invention.

### DETAILED DESCRIPTION OF THE PREFERRED EMBODIMENT

In some embodiments, kits may comprise instructions, one or more cutting patterns, and the structural components needed to customize or decorate a scrapbook or similar item. In some embodiments, the covering material is not included, allowing the user to use materials already in his or her possession or available from other sources. In still other embodiments, the kit includes the covering materials. In some embodiments, the kit does include the scrapbook or item to be personalized. In others it does not include the article to be personalized.

Although the detailed description is described in relation to a scrapbook, items other than scrapbooks may also be personalized. For example, additional embodiments provide kits for customizing and methods of customizing picture frames, photo albums, journals, address books, guest registries, recipe books, tissue boxes, jewelry boxes, hat boxes, memo boards, invitation boards, waste baskets, trash cans, desk pads, blotters, pencil cups, letter trays, lamps, nightlights, brag books, clip boards, expandable file folders, mouse pads, photo boxes, cork boards, note pad holders, lampshades, telephone book covers, CD holders, portfolios, menu covers, agendas, calendars, home accessories, placemats, coasters, window shades, parson's tables, shelves, and the like. In this disclosure, use of the term “scrapbook” should be understood to apply generally to these other items as well in that the concepts of applying these materials to a scrapbook can also be used on any of the foregoing articles.

Embodiments of the invention allow a user to quickly and easily assemble the kit to create the personalized article. The kit permits the user to utilize existing materials, such as fabrics, that may have sentimental value, but that may otherwise provide no utility. Embodiments of the kit provide a relatively fast and easy way for a user to incorporate such existing items into presentable alternatives. In addition, different embodiments of the present invention make it easy for a user to easily assemble a low-cost gift for a friend or loved one.

In the following embodiment, the cover kit is preferably a craft kit which allows the user to add a front and back cover material to the provided cover boards, and then assemble the covered boards to the pre-assembled scrapbook interior.

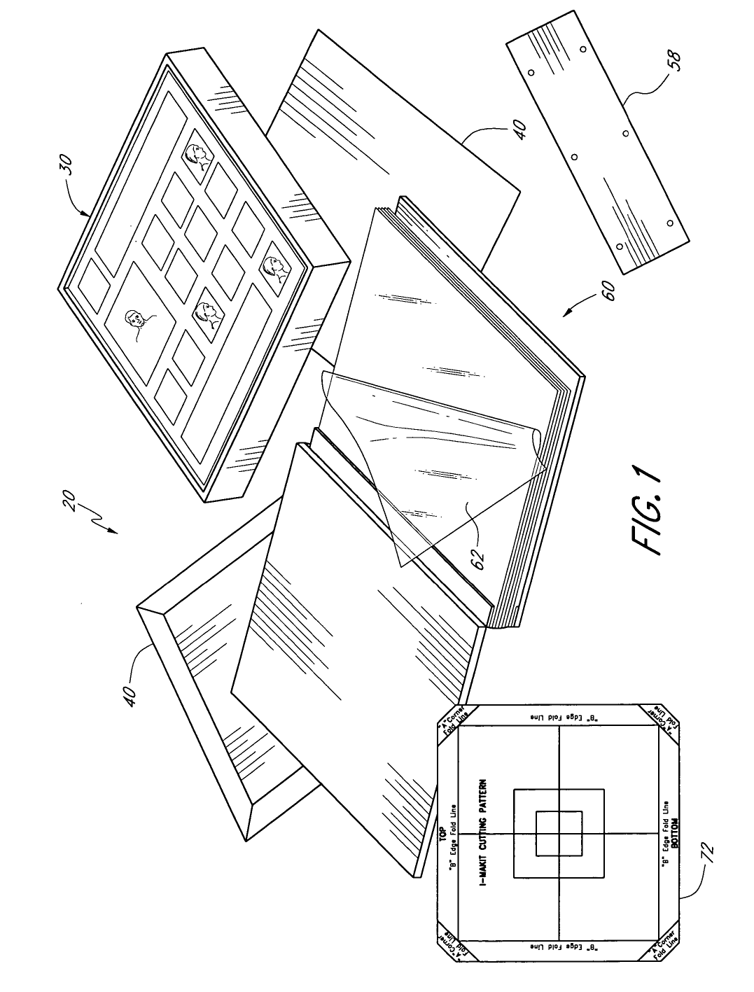

FIG. 1 shows various components of an embodiment of a kit 20. In the illustrated embodiment, the kit 20 comprises a cutting pattern 72, one or more cover boards 40, an assembled interior 60 comprising one or more sheets 62, one or more expandable spine covers 58, an assembly instruction manual and a box 30 for housing the various kit components. One of skill in the art will appreciate that the kit may comprise greater or fewer number of components. In other embodiments, the kits may comprise completely different components. Embodiments make possible a number of alternative shapes and sizes for the scrapbook and its accompanying cutting pattern and cover board.

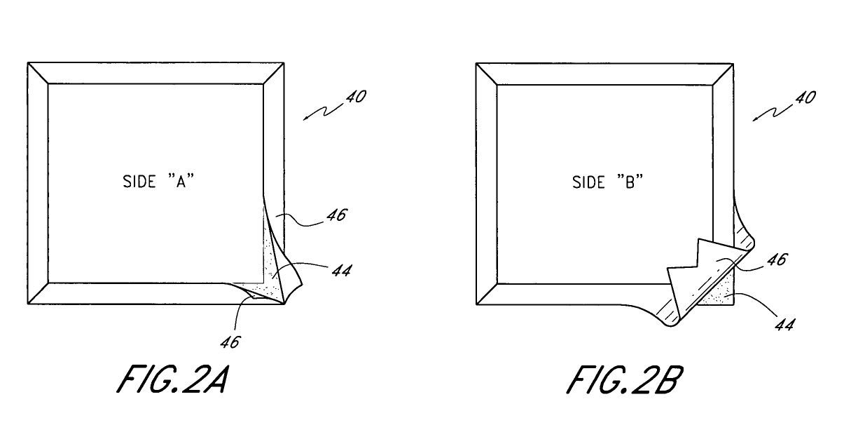

FIGS. 2a and 2b illustrate one embodiment of a cover board 40. The cover board 40 is made from pressed paperboard using wood fibers and glue. However, the cover board 40 may be made from one or more other materials, including, but not limited to, chipboard, cardboard, plastic, metal, or other wood products. In one embodiment, where the kit is intended for the customization of a scrapbook, the dimensions of the cover board 40 are approximately 13 15/16″ wide by 12⅞″ tall by ⅛″ thick. Of course, the exact dimensions of the cover board 40 may vary depending on the item or items being customized.

A first side A of a cover board 40, according to one embodiment, is shown in FIG. 2a. The cover board 40 may preferably comprise one or more adhesive surfaces 44. In one embodiment, each adhesive surface 44 is covered by one or more protective layers 46. Preferably, the protective layer 46 comprises a material that will not permanently attach to the adhesive surface 44. For example, a protective layer 46 may be made of a peel-away strip or sheet of wax-coated paper. Of course, other materials that facilitate the removal of protective layer 46 from the adjacent adhesive surface 44 may be used for the protective layer 46. In one embodiment, as illustrated in FIG. 2a, an adhesive surface 44 is located along the outer edges of one side of a cover board 40. In some embodiments, adhesive surface 44 may cover all or substantially all of side A of cover board 40.

A second side B of a cover board 40 having an adhesive surface 44 and a protective layer 46, according to the same embodiment, is shown in FIG. 2b. As shown in the illustrated embodiment, the protective layer 46 may comprise a single sheet that protects the adhesive surfaces 44 of both sides of a cover board 40. Alternatively, multiple sheets may protect the adhesive surfaces 44. The adhesive surface 44 may be the same or different (e.g., size, shape, pattern, etc.) from one side of a cover board 40 to the other. In one embodiment, as shown in FIGS. 2a and 2b, the adhesive surface 44 covers an entire surface area of one side of a cover board 40, but only the outer edges of the opposite side of the cover board 40.

The adhesive surface 44 of a cover board 40 may comprise a layer of glue or other sticky substance. For convenience, the one or more cover boards 40 included in a kit 20 already include the necessary adhesive surfaces 44. In alternative embodiments, however, one or more cover boards 40 may not include an adhesive surface 44 as provided by a kit. For example, a separate adhesive may be included in the kit, in the form of a roll or sheet, that must be applied by the user as part of the scrapbook assembly. In such embodiments, both sides of the adhesive roll or sheet preferably have peel away protective layers in order to facilitate the application of the sheet to the cover board 40 by the user. Alternatively, a user may have to create the adhesive surface 44 on the cover board 40 by applying a layer of glue, rubber cement, and/or another type of sticky substance. In yet other embodiments, an adhesive surface need not be provided at all, as long as the kit offers an alternative mechanism of securing a covering material to the cover boards (e.g., some mechanical mechanism such as stapling).

The one or more cover boards 40 included in the kit already comprise an adhesive surface 44 covered using a protective layer 46. In one embodiment, the adhesive surface 44 is formed by applying an adhesive sheet on one or more sides of the cover board 40. The adhesive sheet may comprise high performance 200 MP pressure sensitive acrylic adhesive on 58 lb polycoated paper liner. A suitable such material is available from Trinity Manufacturing in Irvine, Calif. Features of such an adhesive sheet may include high temperature formulation, solvent resistance, shear adhesion, and adhesion to materials having high surface energy (HSE) and/or low surface energy (LSE). In one embodiment, the adhesive sheet is 5.0 mil thick and has a 4.0 mil liner or protective layer. Those of ordinary skill in the art will recognize, however, that any suitable adhesive material may be substituted. Such adhesive products may be pre-applied to the one or more cover boards 40 prior to including such cover boards 40 in a kit. In the embodiment depicted in FIGS. 2a and 2b, the approximate dimensions of the adhesive sheet are 17″ by 16″, thus enabling the sheet to envelop an entire side B of a cover board 40 as well as the edges of a second side A of that cover board 40. Alternatively, multiple sheets of adhesive may be used.

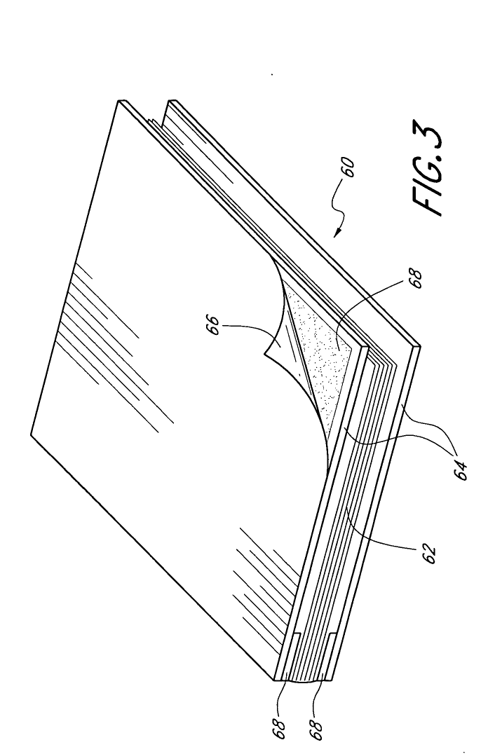

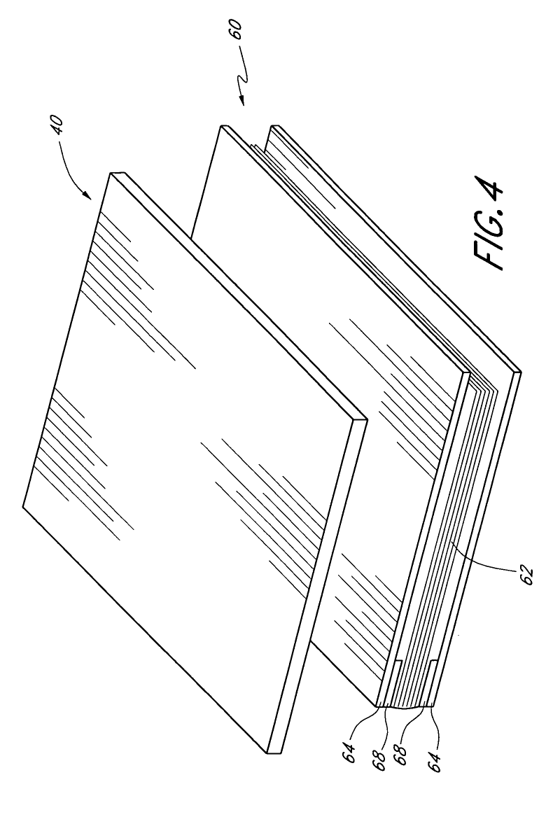

FIG. 3 illustrates one embodiment of an assembled interior 60 of the kit 20 that is particularly well-suited for forming the main part of a scrapbook. The assembled interior 60 may comprise one or more covers 64. In the embodiment shown in FIG. 3, the assembled interior 60 comprises two covers 64, one on each end of the assembled interior 60. As with the cover boards 40, the one or more covers 64 of the assembled interior 60 may be made of chipboard, pressed paperboard made of wood fibers and glue, cardboard, plastic, metal, or any other rigid or semi-rigid material. In one embodiment, where the kit is being used to customize or decorate a scrapbook, the dimensions of each cover 64 are approximately 12 11/16″ by 12¾″ by 1/16″ thick. Of course, the exact shape and/or dimensions of a cover 64 may vary depending on the particular items being customized.

In addition, each cover 64 of the assembled interior 60 may also comprise one or more post strips 68. Each post strip 68 may be made of chipboard, pressed paperboard made of wood fibers and glue, cardboard, plastic, metal, and/or any other rigid or semi-rigid material. The one or more post strips 68 may be made from the same or different material or materials as a cover 64 of the assembled interior 60. In one embodiment, the dimensions of each post strip 68 are approximately 12¾″ by 11/16″ by 1/16″ thick. Of course, the dimensions and/or shape of a post strip may vary depending on the particular items being customized. In addition, the dimensions and/or shape may vary between different post strips 68 included in a particular kit. One or more post strip 68 may be hole punched for binding purposes. In one embodiment, hole punched post strips 68 comprise three holes in order to accommodate a standard hole spacing of the sheets 62 included in the assembled interior 60.

The one or more covers 64 and/or the post strips 68 of the assembled interior 60 may be covered by one or more layers of a lining material. In one embodiment, the lining material comprises a layer of linen fabric. However, one or more of other suitable lining materials may be used, including, but not limited to, other fabrics, paper, plastic, other synthetic or other type of flexible material. The lining material may be applied to one or more sides of a cover 64 or post strip 68. In one embodiment, the lining material covers all portions of the one or more covers 64 and/or post strips 68 of the assembled interior 60. A single sheet or layer of lining material is applied to each cover 60 and its accompanying one or more post strips 68. In such embodiments, the lining material acts to unite the cover 60 and the one or more post strips 68 into a single item.

In other embodiments, however, the covers 64 and/or the post strips 68 of the assembled interior 60 may not comprise a lining material as provided in the kit. Therefore, the user may have to affix a lining material to the one or more covers 64 and/or the one or more post strips 68 of the assembled interior 60 as part of the scrapbook assembly process.

The lining material may be made of a linen fabric and has approximate dimensions of 19¾″ by 13½″ by 1/16″ thick. In such an embodiment, a single piece of lining material is used for each cover 64 and the one or more post strips 68 associated with that cover 64. However, depending on the particular item being customized, a lining material of different shape and/or size may be used. In other embodiments, a lining material may not be necessary at all.

As with the cover boards 40, each cover 64 of the assembled interior 60 may comprise an adhesive surface 68. Preferably, each cover 64 of the assembled interior 60 provided in the kit already comprises an adhesive surface 68. In the embodiment illustrated in FIG. 3, the adhesive surface 68 is covered by a protective layer 66. In such embodiments, an adhesive surface 68 is formed by applying an adhesive sheet to one or more sides of the cover 64. The adhesive sheet may comprise high performance 200 MP pressure sensitive acrylic adhesive on 58 lb polycoated paper liner. A suitable such material is available from Trinity Manufacturing in Irvine, Calif. Features of such an adhesive sheet may include high temperature formulation, solvent resistance, shear adhesion, and adhesion to materials having HSE and/or LSE. In one embodiment, the adhesive sheet is 5.0 mil thick and has a 4.0 mil liner or protective layer. Those of ordinary skill in the art will recognize, however, that any suitable adhesive material may be substituted. Such adhesive products may be pre-applied to the one or more covers 64 prior to placing the assembled interior 60 in a kit. In the embodiment depicted in FIG. 3, the approximate dimensions of the adhesive sheet are 13⅜″ by 12⅜″. Alternatively, a user may be required to create the adhesive surface 68 on the one or more covers 64 of the assembled interior 60 by applying a layer of glue, rubber cement, and/or another type of sticky substance.

The assembled interior 60 of the kit may also comprise one or more sheets 62. In one embodiment for customizing a scrapbook (shown in FIG. 3), the one or more sheets 62 comprise acid-free poly propylene page protectors having an approximate dimension of 13⅜″ by 12 7/16″. For example, in an embodiment particularly well-suited for customizing a scrapbook, the assembled interior 60 comprises between 5 and 30 sheets 62. In a more preferred embodiment, the assembled interior 60 comprises ten sheets 62. However, those of ordinary skill in the art will recognize that the assembled interior 60 may comprise more or fewer sheets 62. In addition, the sheets 62 may be constructed of different materials and may have different shapes. In some embodiments, the assembled interior 60 may comprise sheets 62 of different types, shapes, and/or sizes. For example, a single assembled interior 60 may include sheets for storing photographs, sheets for displaying ticket stubs, memorabilia and other items, sheets for displaying cards and other sheets of paper, etc.

The one or more covers 64 and the one or more sheets 62 of the assembled interior 60 are preferably bound. In one embodiment, the binding is accomplished using screw posts. However, those of ordinary skill in the art will appreciate that many other binding methods may be used, including, but not limited to, ring, comb binding, coil binding, wire binding, thermal binding, stitch binding, tabs, or sliders. For binding purposes, an assembled interior may comprise one or more male screw posts and a corresponding number of female screw posts. In one embodiment, both the male screw posts and the female screw posts are approximately ¼″ by ⅜″. The screw posts may be constructed of aluminum or any suitable metal or plastic material.

The assembled interior 60 may also comprise one or more spine covers 58 in order to enhance the appearance of the scrapbook or other customized item. In one embodiment, a spine cover 58 is provided having approximate dimensions of 2″ by 12½″. The spine cover is preferably hole punched to match the hole configuration of the one or more covers 64 and the sheets 62 of the assembled interior 60. Regardless of what fastening or binding system the assembled interior 60 uses, a spine cover 58 should be configured to accommodate such a system. In one embodiment, the spine cover 58 may comprise a sheet of paper bonded to a fabric lining. Any other suitable material or combination of materials, however, may be used for the one or more spine covers 58.

The kit may comprise more than one spine cover 58 in order to better accommodate the number of sheets 62 included in the assembled interior 60. For example, in one embodiment, the kit is provided with a larger spine cover 58, having approximate dimensions of 4″ by 12½″. Thus, such a larger spine cover 58 may allow the user to add pages to the finished scrapbook or other customized product.

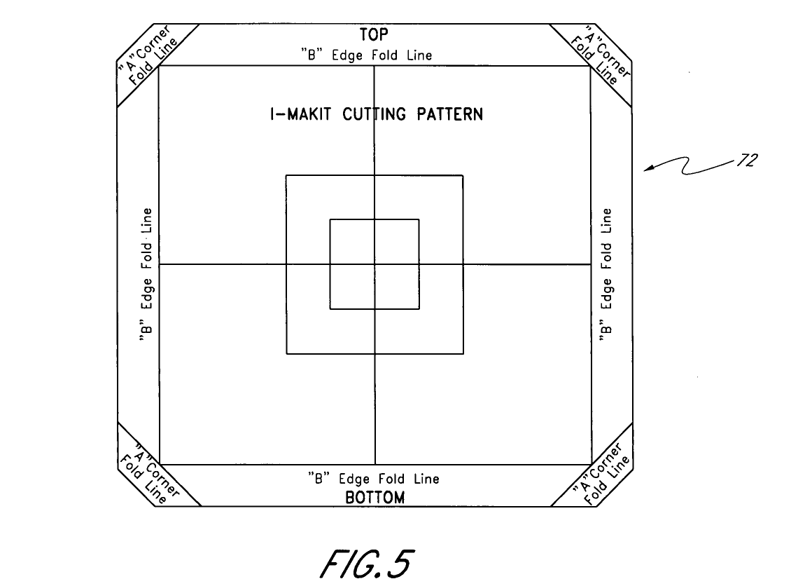

The kit may also include a cutting pattern 72 (FIG. 5). In one embodiment, the cutting pattern 72 is made of lightweight, semi-transparent paper, and has approximate dimensions of 16⅛″ by 15″. Of course, the exact material used for the cutting pattern 72 is not significant. In addition, the size and/or shape of the cutting pattern 72 should be customized according to the particular scrapbook or item being customized.

In one embodiment, the various components of the kit may be assembled using the steps detailed below. The discussion will concentrate on an embodiment of customizing a scrapbook. However, those of skill in the art will appreciate that similar steps may be used to customize another item.

Initially, the user should select a cover material that will be used to decorate or customize the scrapbook. Personalized cover choices are unlimited and ideas for the cover may include a sports jersey, shirt, scouting uniform, bowling shirt, bride's maids dress, cross-stitch, needlepoint, or a paper product. In some embodiments, the cover material may even be included in the kit. Whichever theme is selected can be embellished with a heat transfer, embroidery, beading, monogram, appliqué, patch, ribbons, etc. In certain embodiments, some or all of these embellishments may be included in the kit.

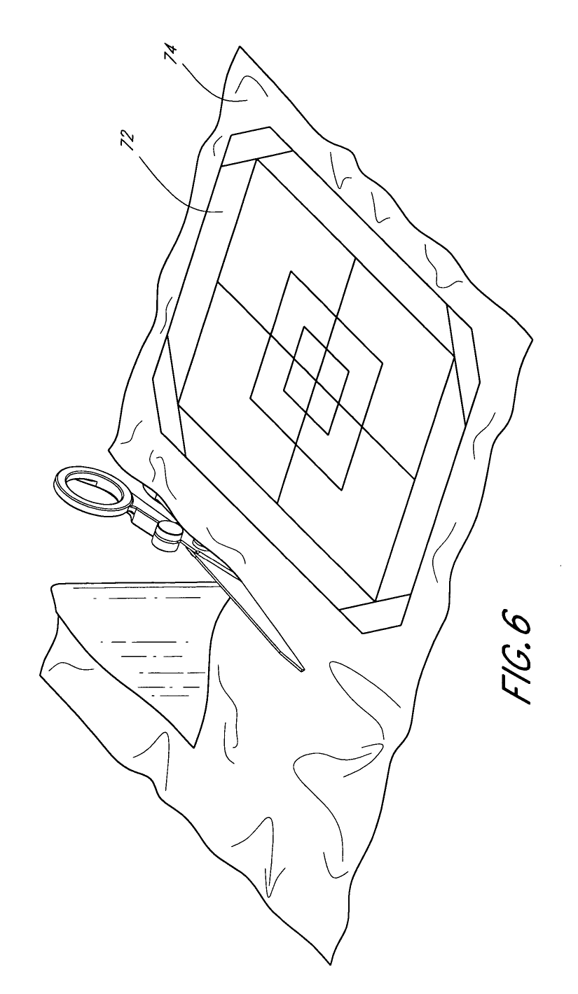

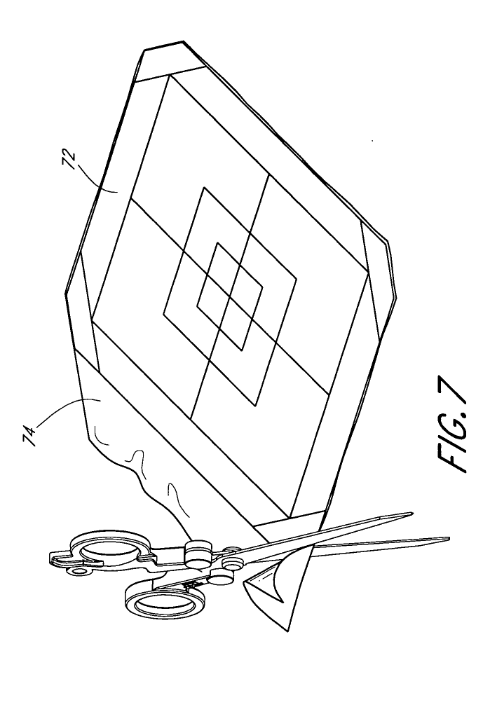

The user cuts the one or more selected cover material to a suitable shape. Cutting of the cover material 72 may be performed using a cutting pattern 72 provided in the kit, as illustrated in FIGS. 6 and 7. In one embodiment, the dimensions of the cover material 72 should measure 14¾″ tall by 15½″ wide. The user may use the same or different materials on the one or more cover boards 40. In one embodiment having two cover boards 40, the same or different cover material 72 may be used on each cover board 40.

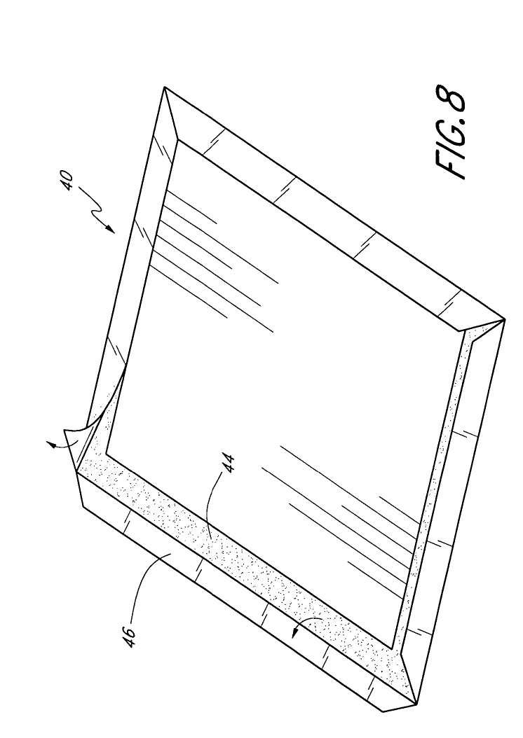

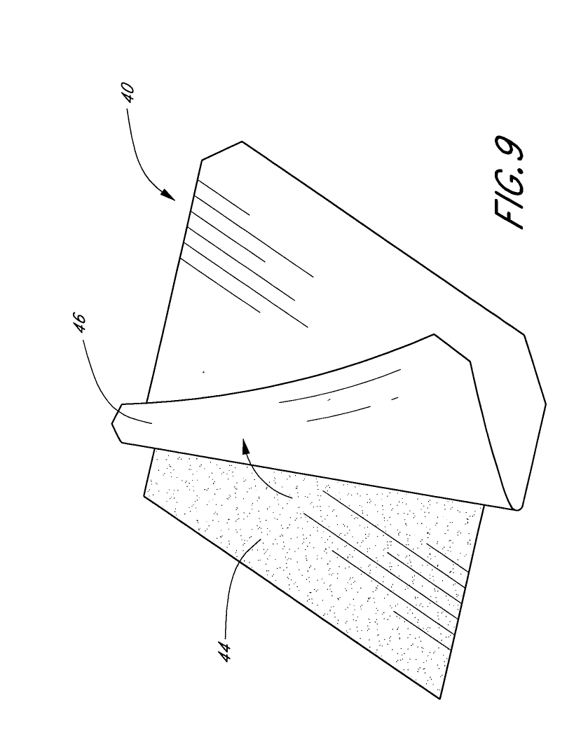

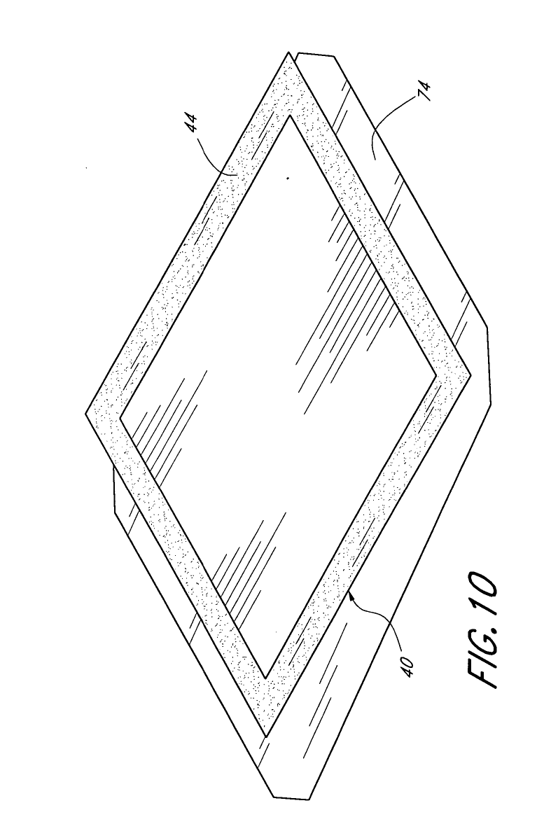

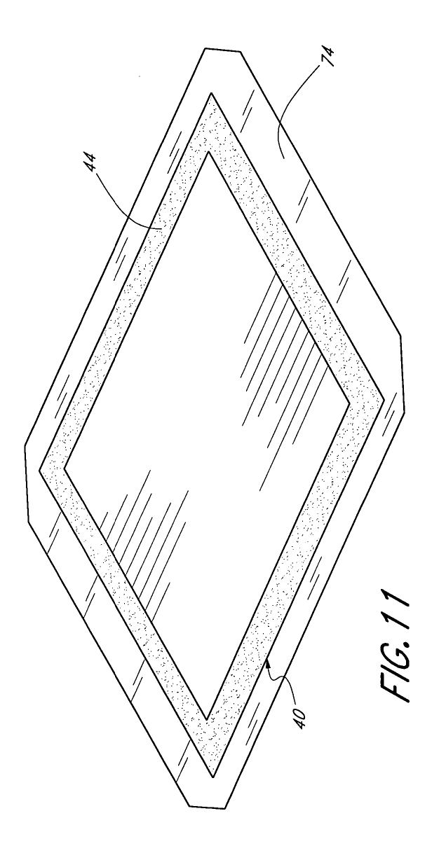

Next, the adhesive surface 44 of each cover board 40 is revealed by removing the protective layer 46. In the illustrated embodiment, the adhesive surface 44 is one the edges of a first side of each cover board 40 and along the entire second side of each cover board 40. As shown in FIGS. 8 and 9, the user peels away the protective layer 46 from both sides of the cover board 40 to expose the adhesive surface 44. The cover material 72 is preferably placed on a smooth, hard surface with the desired exterior (e.g., decorative) surface face down. As illustrated in FIGS. 10 and 11, having centered the cover board 40 over the cover material 72, the user applies the cover board 40 onto the cover material 72. In one embodiment, the cover board 40 side with the larger adhesive surface 44 is positioned on the flat cover material 74 first. The cover material 72 is then smoothed out on the cover board 40.

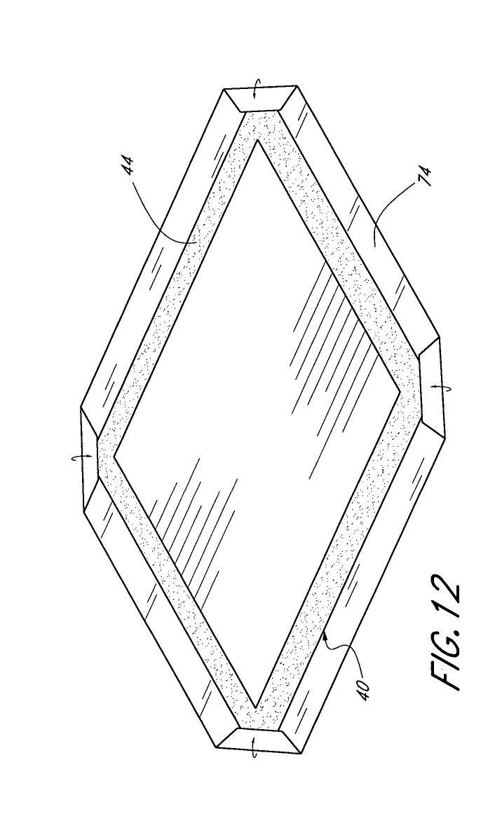

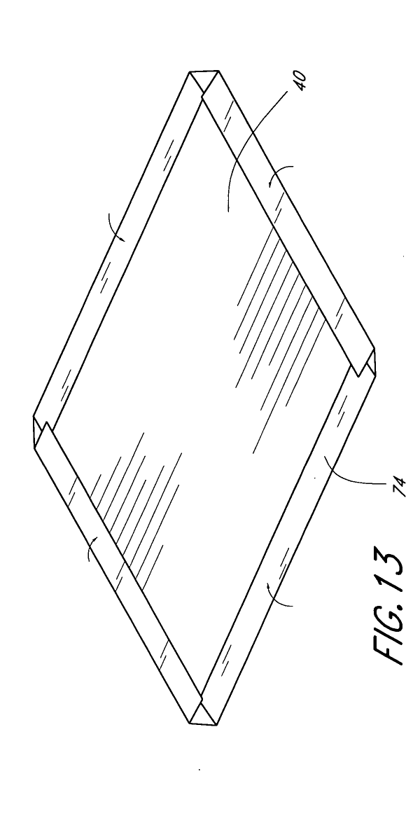

The user then folds the edges of the cover material 72 around the sides of the cover board 40. In one embodiment depicted in FIGS. 12 and 13, the folded cover material 72 adheres to the adhesive surface 44 located along the sides of the other side of the cover board 40.

The user repeats the steps above to cover any other cover boards 40 of the kit that he or she wishes to decorate with a cover material 72.

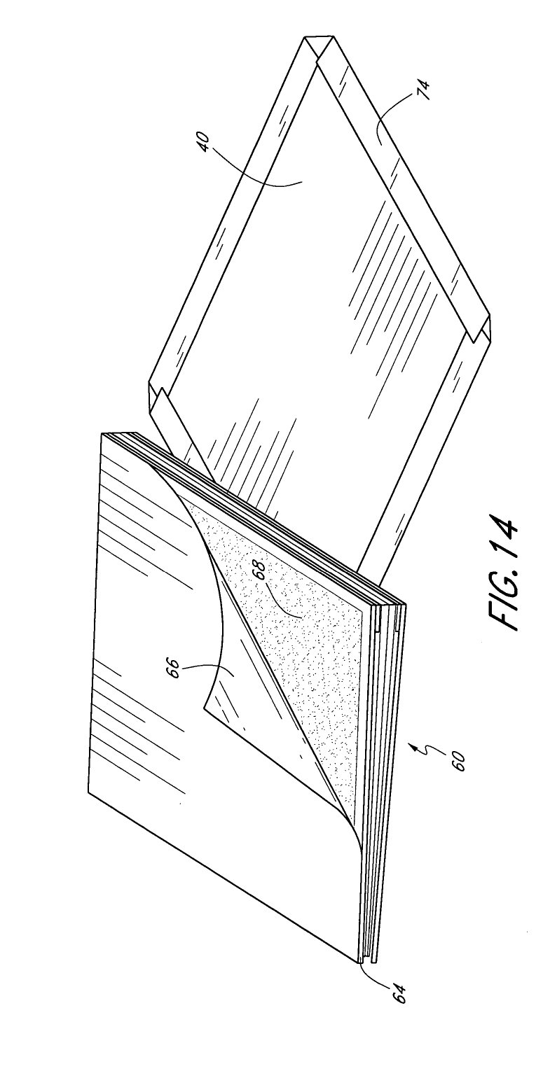

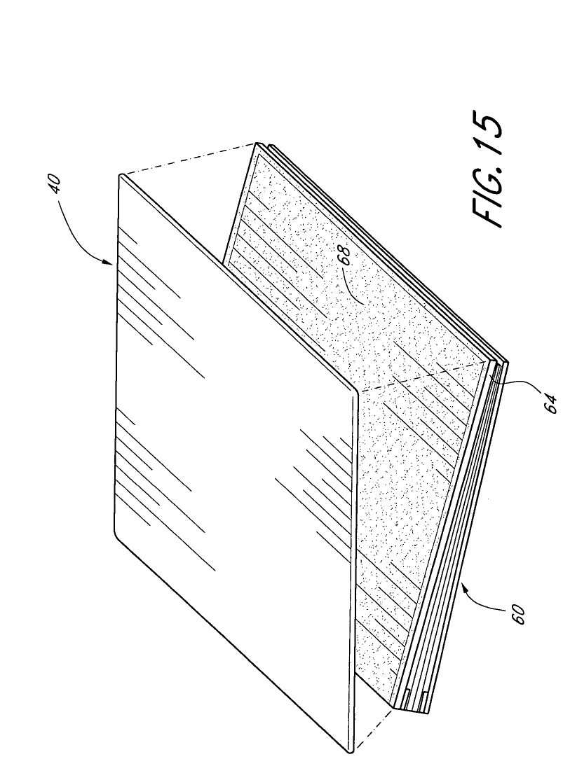

Assembly of the kit continues by attaching one or more cover boards 40 to the assembled interior 60. The user begins by exposing one or more adhesive surfaces 68 on a cover 64 of the assembled interior 60. In one embodiment, as illustrated in FIG. 14, the adhesive surface 68 of the cover 64 of the assembled interior 60 is exposed by removing a protective layer 66. A cover board 40 is then aligned over the cover 64 of the assembled interior 60 (FIG. 15) and pressed onto the exposed adhesive surface of the cover 64. The user repeats the above procedure for attaching any additional cover boards 40 to the assembled interior 60.

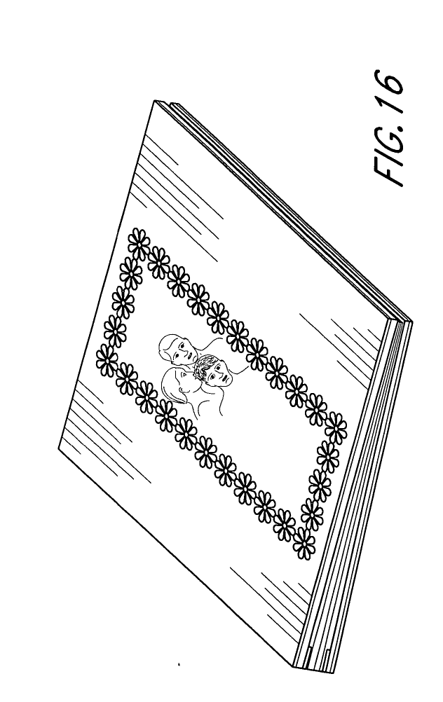

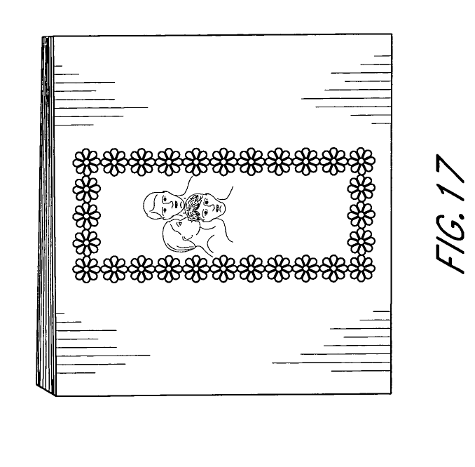

The appearance of a finished scrap book (FIGS. 16 and 17) may be further modified by including additional features. In some embodiments, decorative items may be attached (e.g., glued, stapled, or otherwise fastened) to the outside covers of the scrapbook. For example, the user may add ribbons, glitter, ornaments, photographs, beads, fabric, or any other item to the scrapbook covers. In some embodiments, the user may modify the scrapbook's appearance by drawing or painting on one or more of the scrapbook surfaces. In some embodiments, a user's initials or a title describing the theme of the scrapbook may be added.

The bonding strength between the different bonded surfaces described herein may be increased by using additional adhesives such as glue. In some embodiments, the additional adhesive may be applied to the surfaces using a glue gun, adhesive spray, or any other suitable binding mechanism.

As discussed, the user can personalize the scrapbook or other item by using one or more cover materials from a wide variety of sources such as fabric stores or craft shops or their own personal collections of materials such as old dresses, skirts, shirts, blankets, quilts, sheets, etc. However, in some embodiments, the covering material and additional decorative materials may be included. Further, the kit may include additional adhesives in the form of glues, double sticky tapes, and the like to allow for additional personalization over and above the attachment of the covering material. Different kits may have different themes, such as sports, nature, animals, crafts, etc. Such themes may be enhanced or defined by the various decorative materials included therein.

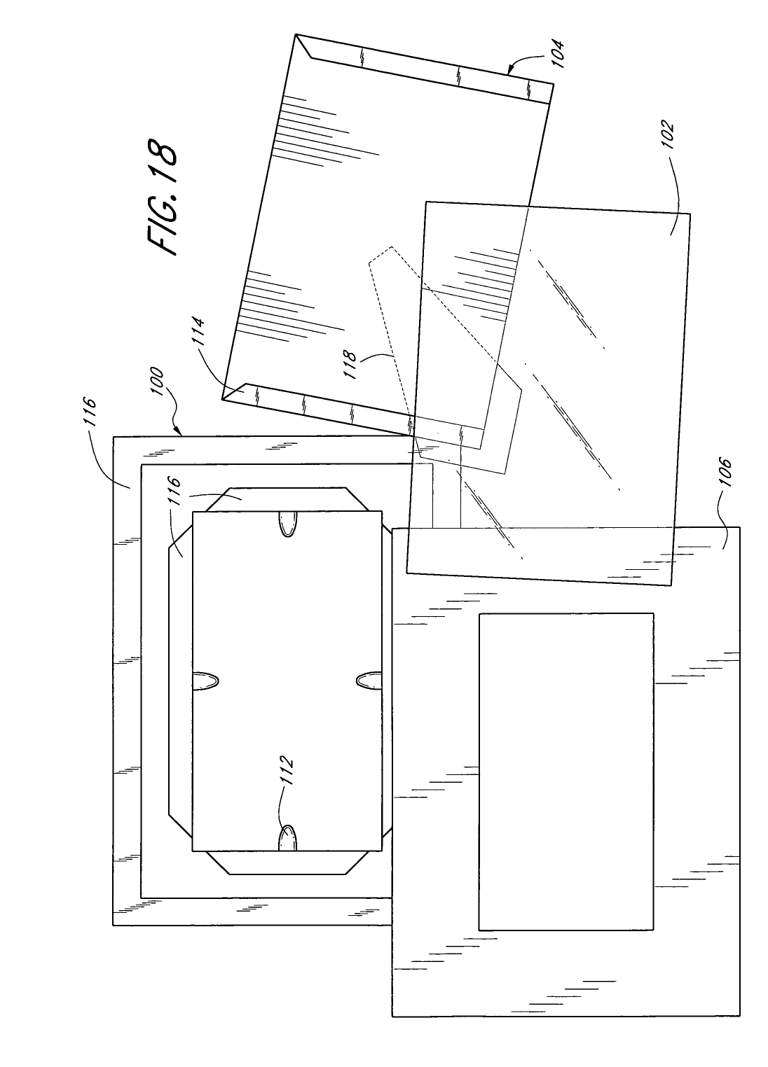

FIG. 18 shows alternative parts for use with another embodiment of the invention. This embodiment includes materials for personalizing a picture frame. In the embodiment illustrated in FIG. 18, a frame cover 106 includes an adhesive surface on its front and/or rear side. A fabric or other customizing material may be applied to the frame cover 106 by exposing or creating the one or more adhesive surfaces on the frame cover 106 and applying the fabric or other material to them. This is similar to the embodiments discussed above related to the customization of cover boards 40 in relation to a scrapbook kit. Once the frame cover has been customized with the fabric or other material, one or more adhesive surfaces 116 on the frame's main body 100 are created or exposed. In one embodiment, the frame cover 106 may then be aligned with and positioned on the main body 100. A photograph holder 104 may also be provided. In one embodiment, the photograph holder 104 comprises one or more adhesive surfaces 114 to secure the photograph to the photograph holder 104. In some embodiments, a piece of glass or other protective material such as transparent or partially transparent plastic 102 may be provided. The piece of glass 102 and the photograph holder 104 may collectively be secured on the rear side of the main body 100, and secured to the main body using one or more tabs 1112. In one embodiment, the photograph holder 104 is provided with a stand 118.

Although the foregoing invention has been described in terms of certain embodiments, other embodiments will be apparent to those of ordinary skill in the art from the disclosure herein. Additionally, other combinations, omissions, substitutions, and modifications will be apparent to the skilled artisan in view of the disclosure herein. Accordingly, the present invention is not intended to be limited by the reaction of the preferred embodiments, but is to be defined by reference to the appended claims.

What is claimed is:

1. A kit for use in modifying the outward appearance of an article, said kit comprising:
instructions;
at least one cutting pattern;
a main article comprising an adhesive on at least a portion of its surface with a removable protective layer covering the adhesive; and
at least one covering portion comprising an adhesive on at least a portion of its surface with a removable protective layer covering the adhesive.

2. The kit of claim 1, further comprising a covering material for use with the main article.

3. The kit of claim 2, wherein the covering material is a fabric.

4. The kit of claim 1, wherein the main article is a book.

5. The kit of claim 4, wherein the covering portions are cover boards configured for use with a book.

6. The kit of claim 4, wherein the book is a scrapbook.

7. The kit of claim 1, wherein the main article is a picture frame.

8. A kit for use in modifying the outward appearance of an article, said kit comprising:
at least one cutting pattern;
a main article comprising an adhesive on at least a portion of its surface; and
at least one covering portion comprising an adhesive on at least a portion of its surface.

9. The kit of claim 8, further comprising a covering material for use with the main article.

10. The kit of claim 8, wherein the main article is a book.

11. A method for modifying the outward appearance of an article, said method comprising:
supplying at least one cutting pattern;
supplying a main article comprising an adhesive on at least a portion of its surface with a removable protective layer covering the adhesive; and
supplying at least one covering portion comprising an adhesive on at least a portion of its surface with a removable protective layer covering the adhesive and
supplying instructions for assembling the said main article and said at least one covering portion.

12. The method of claim 11, wherein the main article is book.

13. The method of claim 11, wherein the main article is a picture frame.
